(19) United States
(12) Patent Application Publication
(10) Pub. No.: US 2010/0287025 A1
(43) Pub. Date: Nov. 11, 2010

(54) MOBILE RESOURCE TASK SCHEDULING

(76) Inventors: Brian Fletcher, Felixstowe (GB); Robert Laithwaite, Ipswich (GB); Robert Collins, Bedford (GB)

Correspondence Address: TRIMBLE NAVIGATION LIMITED C/O WAGNER BLECHER, 123 WESTRIDGE DRIVE, WATSONVILLE, CA, 95076, US

(21) Appl. No.: 12/641,152

(22) Filed: Dec. 17, 2009

Related U.S. Application Data
(60) Provisional application No. 61/176,012, filed on May 6, 2009.

(51) Int. Cl. G06Q 10/00

(52) U.S. Cl. 705/9; 705/8

(57) ABSTRACT

In a method for scheduling tasks for a mobile resource, task schedule data for a mobile resource is accessed. The task schedule data comprises a scheduled location of the mobile resource, and the task schedule data is planned before initiation of the task. The task schedule data and the real-time location data of the mobile resource are correlated. An alert is transmitted in real-time based on correlating the task schedule data and the real-time mobile resource location data.

### CROSS-REFERENCE TO RELATED APPLICATION

This application claims priority to and benefit of U.S. provisional patent application 61/176,012 filed May 6, 2009, which is incorporated herein, in its entirety, by reference.

### BACKGROUND

Field force management systems desire compliance of scheduled tasks and achieving corporate targets through tracking movements of the field force (e.g., mobile resources) and reporting their actions. Field asset management systems provide the ability to assess whether the field work force has the products, kits and equipment to carry out the scheduled tasks. Field asset management systems also ensure the assets (e.g., products, kits and equipment) are fit for their purposes through remote diagnostic checks and by providing notification when problems are identified. However, monitoring and assessing (1) compliance of dispatched scheduled tasks, (2) movement and availability of assets relating to dispatched scheduled tasks, and (3) reported actions from the field work force can be manually intensive.

Moreover, scheduling systems often rely on field workforce compliance related to executing the scheduled tasks and providing accurate feedback regarding current activity and location. Often the compliance and/or feedback are lacking, resulting in potentially inaccurate assumptions as to whether a field worker is in the right location or has the equipment necessary to do a task. Accordingly, this can severely disrupt operation and negatively affect customer perceptions of service.

### BRIEF DESCRIPTION OF THE DRAWINGS

FIG. 1 illustrates an example of a mobile resource task scheduling system, in accordance with an embodiment of the present invention.

FIG. 2A illustrates an example of a scheduled task, in accordance with an embodiment of the present invention.

FIG. 2B illustrates an example of a scheduled task, in accordance with an embodiment of the present invention.

FIG. 2C illustrates an example of a scheduled task, in accordance with an embodiment of the present invention.

FIG. 2D illustrates an example of a scheduled task, in accordance with an embodiment of the present invention.

FIG. 3 illustrates an example of a display, in accordance with an embodiment of the present invention.

FIG. 4 illustrates an example of a display, in accordance with an embodiment of the present invention.

FIG. 5 illustrates a flow diagram of a method for scheduling tasks for a mobile resource, in accordance with an embodiment of the present invention.

FIG. 6 illustrates a block diagram of an example computer system, according to an embodiment, with which or upon which embodiments of the present invention can be implemented.

The drawings referred to in this description should be understood as not being drawn to scale except if specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications and equivalents, which may be included within the spirit and scope the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “accessing,” “correlating”, “changing,” “transmitting,” “determining,” “displaying,” “assigning,” “scheduling,” “rescheduling,” “generating,” or the like, often refer to the actions and processes of an electronic computing device or system, such as a mobile resource task scheduling system, among others. The electronic computing device/system transmits, receives, stores, manipulates and/or transforms signals represented as physical (electrical) quantities within the circuits, components, logic, and the like, of the electronic computing device/system into other signals similarly represented as physical electrical quantities within the electronic computing device/system or within or transmitted to other electronic computing devices/systems.

### Example Mobile Resource Task Scheduling System

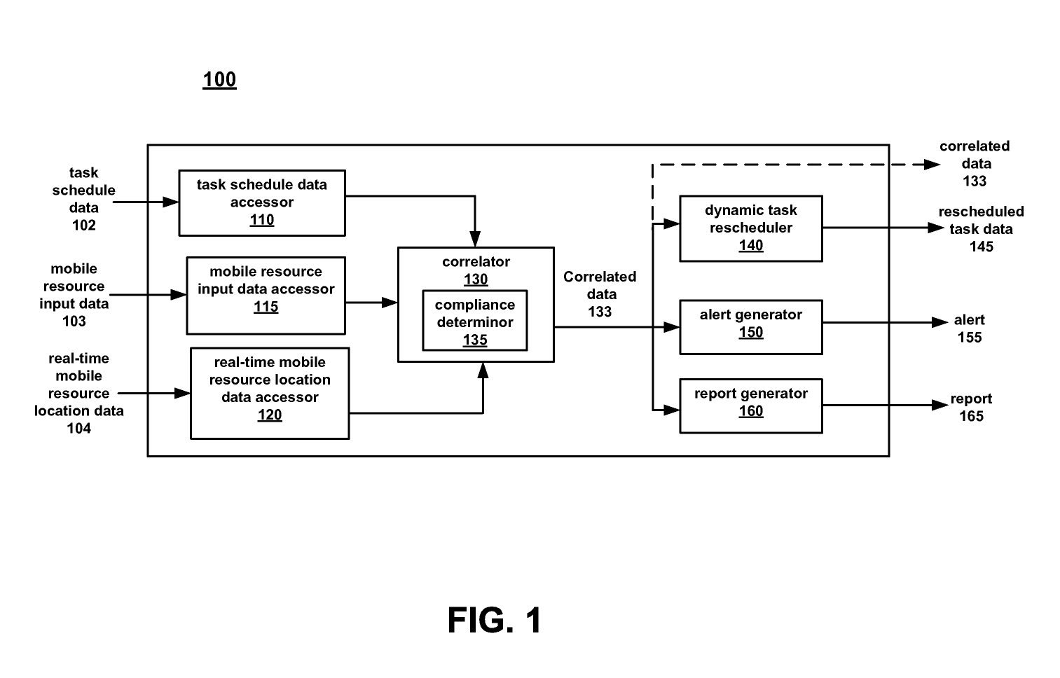

FIG. 1 is an example block diagram showing a mobile resource task scheduling system 100, in accordance with an embodiment. Mobile resource task scheduling system 100 is configured to intelligently schedule/reschedule tasks for mobile resources in real-time, with limited to no human effort. Mobile resource task scheduling system 100 includes a task schedule data accessor 110, a mobile resource input data accessor 115, a real-time mobile resource location data accessor 120 and a correlator 130.

Task schedule data accessor 110 is configured to access task schedule data 102 of a task for a mobile resource. A mobile resource can be, but is not limited to, a person who receives a scheduled task or a vehicle used to transport the person. It should be appreciated that task schedule data accessor 110 can access task schedule data 102 by receiving, actively pulling, etc. A task can be any task assigned to a mobile resource, such as, but not limited to, repairing equipment, deliveries, security checks, etc.

Task schedule data 102 can be, but is not limited to, any data associated with a task scheduled for a mobile resource. In one embodiment, task schedule data 102 includes at least (1) a pre-planned mobile resource location (e.g., at home, at task location, at depot) with respect to a scheduled task and (2) a pre-planned mobile resource activity (e.g., driving between task destinations, stopping for meals, working at a task location) with respect to the scheduled task. It should be appreciated that the task schedule is planned before initiation of the task. Accordingly, task schedule data 102 is planned before initiation of the task.

In one embodiment, the task schedule data 102 can be the information described in the following example. Employee A is scheduled to complete Task A, Task B and Task C in series. The estimated travel time to complete the scheduled tasks is 50 minutes (e.g., 15 minutes from Task A to Task B and 35 minutes from Task B to Task C). Additionally, Employee A is scheduled for a travel time of 30 minutes from the office to the location of Task A and 45 minutes from the location of Task C back to the office.

Task schedule data 102 can include schedule tolerances. The schedule tolerances allow for a reasonable and allowable time period for a mobile resource to start and/or complete a task. For example, in the above example, Employee A is scheduled to start Task A at 8:00 AM. However, a schedule tolerance of ten minutes allows for Employee A to start Task A no later than 8:10 AM without jeopardizing the scheduled completion time of Task A and/or any other scheduled subsequent tasks (e.g., Task B and Task C).

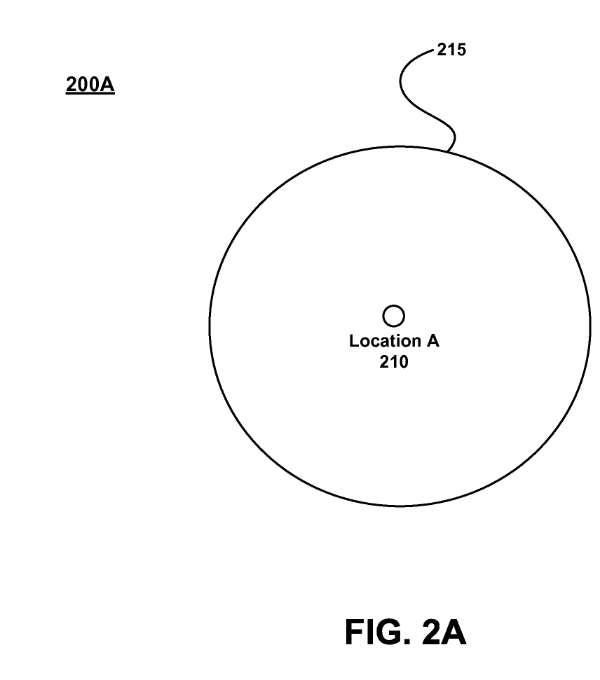

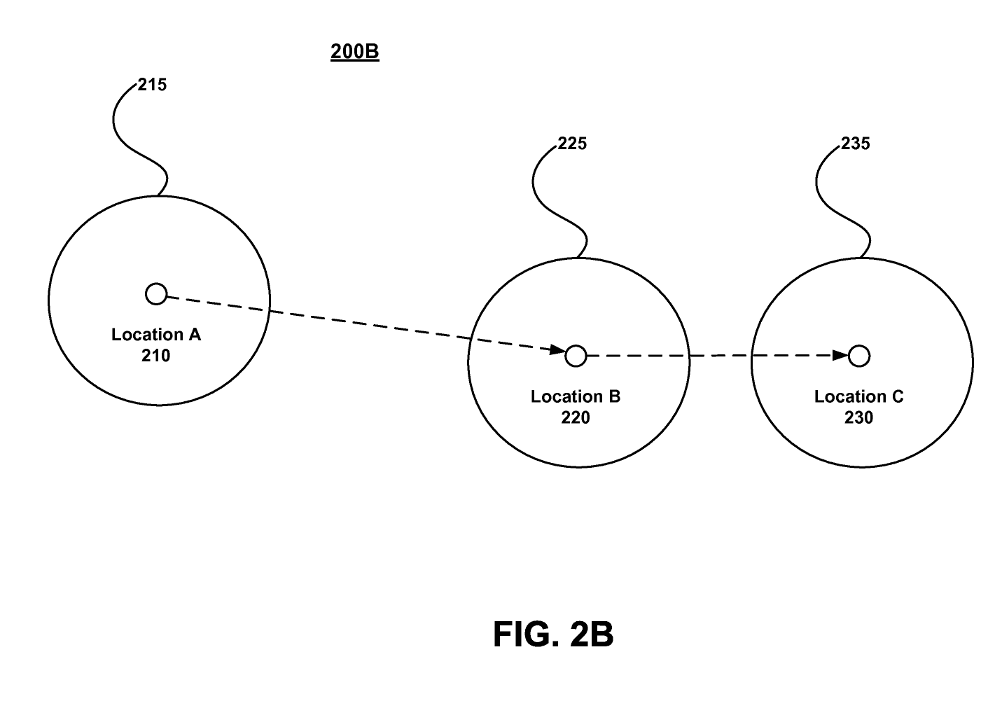

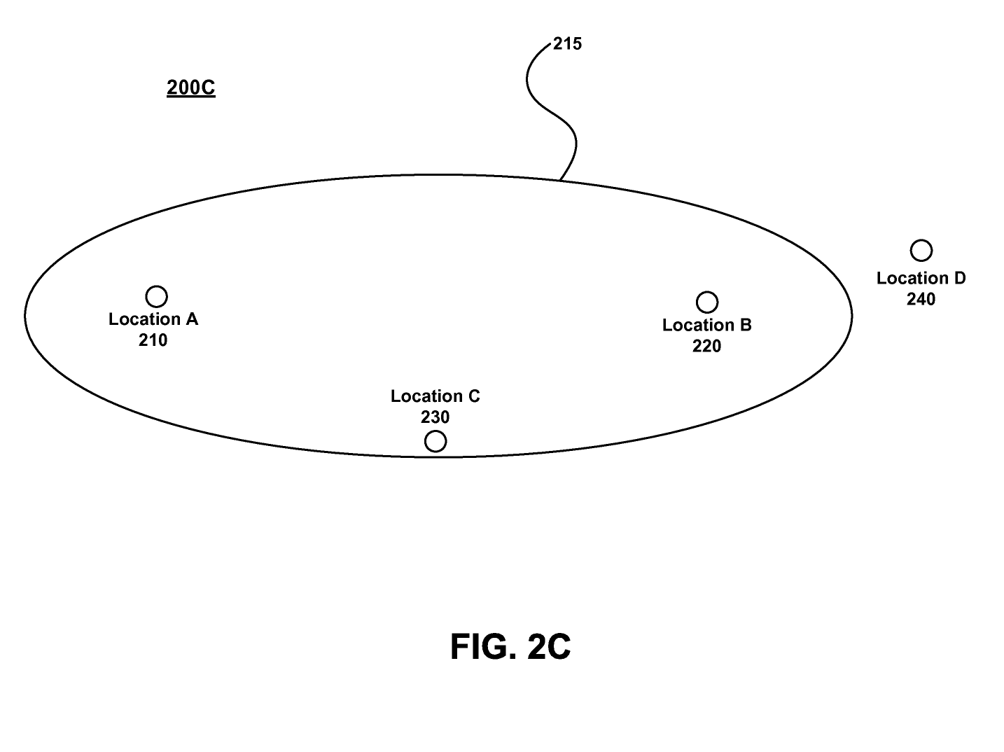

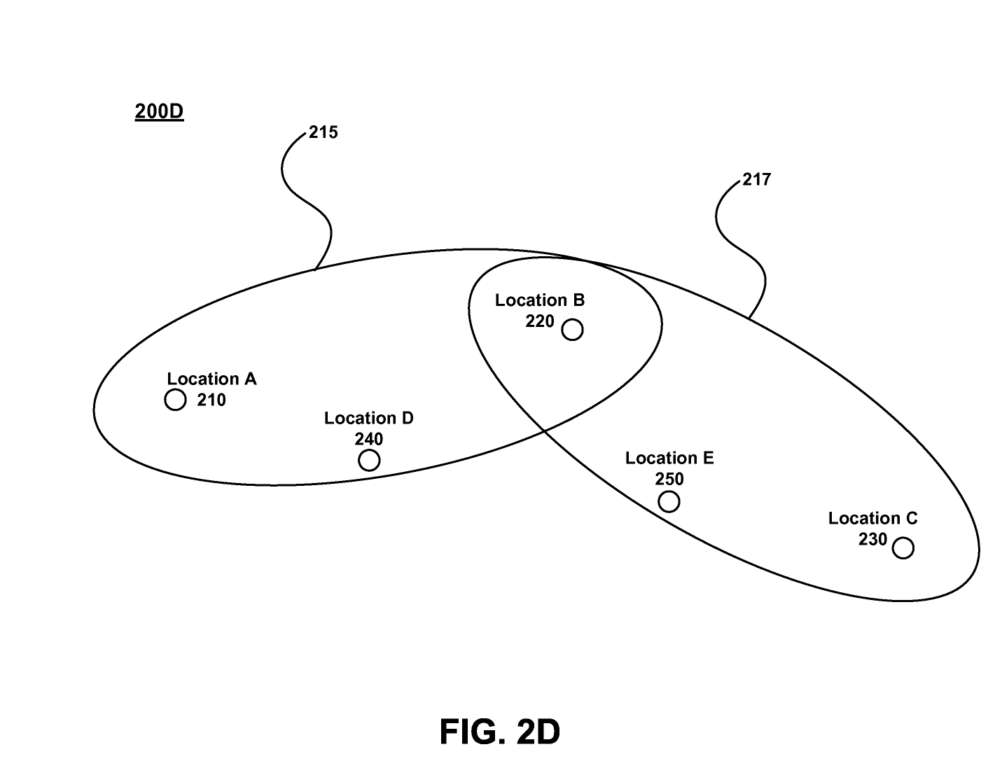

FIGS. 2A-D illustrate task schedule(s) 200A-D with associated task vicinities, in accordance with various embodiments. In general, a task vicinity is a scheduled tolerance of where a mobile resource should be in association to a scheduled task. Moreover, it should be appreciated that a task vicinity can be used (1) to determine if a mobile resource is parked at a valid work location for alerting purposes and (2) in reporting the efficiency and effectiveness of a mobile resource based on the period of time it spends in the task vicinity, which is described in detail later.

FIG. 2A illustrates a task schedule 200A includes a single task 210, in accordance to an embodiment. For example, Employee A is scheduled to complete a single scheduled task at a single Location A 210 (e.g., a customer location). In other words, for Employee A to complete this scheduled task, Employee A only needs to work within task vicinity 215. Accordingly, task vicinity 215 (in the shape of a circle) surrounds Location A 210.

FIG. 2B illustrates a scheduled task 200B includes a plurality of tasks, in accordance to an embodiment. In one embodiment, task schedule 200B includes a plurality of tasks at a plurality of respective locations. To complete task schedule 200B, a mobile resource must complete each sub-task at the sub-task's specific location. For example, Employee A is scheduled to complete Task A at Location A 210, then complete Task B at Location B 220 and then complete Task C at Location C 230. In other words, for Employee A to complete task schedule 200B, Employee A only needs to work within task vicinity 215 (to accomplish Task A), within task vicinity 225 (to accomplish Task B) and within task vicinity 235 (to accomplish Task C). Accordingly, task vicinities 215, 225 and 235 (each in the shape of a circle) surrounds Location A 210, Location B 220 and Location C, respectively.

FIG. 2C illustrates a task schedule 200C includes a plurality of tasks, in accordance to an embodiment. In one embodiment, task schedule 200C includes a plurality of tasks at a plurality of respective locations. However, a mobile resource may have to work at locations outside of and/or in between the task locations (e.g., Location A 210 and/or Location B 220) to accomplish task schedule 200C.

In one embodiment, Employee A is scheduled to complete Task A at Location A 210, then complete Task B at Location B 220. However, Task A and Task B can be associated with a network. As such, work can be scheduled and/or required outside of Location A 210 and/or Location B 220 to accomplish Task A and/or Task B of task schedule 200C. For example, Employee A may be required travel to Location C 230 (e.g., a depot that stores assets and/or tools) to facilitate in completing Task A and/or Task B. Accordingly, task vicinity 215 surrounds Location A 210, Location B 220 and Location C 230 in a shape of an ellipse. In another embodiment, Location A 210 and Location B 220 are foci of ellipse (e.g., task vicinity 215).

If Employee A exits task vicinity 215 (e.g., Location D 240), Employee A jeopardizes the scheduled completion time of the scheduled tasks (e.g., Task A and/or Task B). It should be appreciated that a task schedule can include any number of tasks and/or any number of locations. A single task can include a plurality of sub-tasks at a plurality of different locations. It should also be appreciated that a task vicinity can be any shape that is compatible with any number of tasks at any number of locations. The scheduled tolerances (e.g., task vicinity) can be based on statistical analysis.

FIG. 2D illustrates a task schedule 200D includes a plurality of tasks, in accordance to an embodiment. In one embodiment, task schedule 200D includes a plurality of tasks at a plurality of respective locations. However, a mobile resource may have to work at locations outside of and/or in between task locations (e.g., Location A 210, Location B 220 or Location C 230) to accomplish scheduled task 200D.

In one embodiment, Employee A is scheduled to complete Task A at Location A 210, complete Task B at Location B 220 and then complete Task C at Location C 230. However, Task A and Task B can be associated with a network and Task B and C can be associated with another network. As such, work can be scheduled and/or required outside of Location A 210, Location B 220 and/or Location C 230 to accomplish Task A, Task B and/or Task C of task schedule 200D. For example, Employee A may be required travel to Location D 240 (e.g., a depot that stores assets and/or tools) to facilitate in completing Task A and/or Task B. Likewise, Employee A may be required travel to Location E 250 (e.g., a depot that stores assets and/or tools) to facilitate in completing Task B and/or Task C. Accordingly, task vicinity 215 surrounds Location A 210, Location B 220 and Location D 240 and task vicinity 217 surrounds Location B 220, Location C 230 and Location E 250 in a shape of an ellipse.

Referring now to FIG. 1, mobile resource input data accessor 115 is configured to access mobile resource input data 103. This accessing can comprise passively receiving mobile resource input data 103 or actively pulling or polling for real-time location data 103.

Mobile resource input data 103 is any data generated by a mobile resource that facilitates in accomplishing a scheduled task. For example, with reference to FIG. 2C, Employee A is scheduled to complete Task A at Location A and Task B at Location B before the end of the work day. After completing Task A, Employee A generates mobile resource input data 103 that specifies that Employee A has completed Task A and is going to Location C 230 to pick up a tool in order to accomplish Task B at Location B. It should be appreciated that mobile resource input data can be generated via e-mail, cell phone, pager, instant messaging, any short message service (SMS) and the like.

Referring to FIG. 1, real-time mobile resource location data accessor 120 accesses real-time location data 104 associated with the mobile resource. This accessing can comprise passively receiving real-time location data 104 or actively pulling or polling for real-time location data 104. The real-time location of the mobile resource can be provided by a geo-location system(s) such as but not limited to terrestrial networks of transmitters (e.g., Loran), networks of satellites (e.g. global positioning satellites (GPS), Galileo, Global Navigation Satellite System (GLONASS)), cellular mobile telephone networks, radio transmitter networks and/or any combination thereof.

The term “real-time,” with respect to real-time location, is defined as the instantaneous location of the mobile resource as indicated by a geolocation system. It should be appreciated that the instantaneous location of the mobile resource constantly changes if the mobile resource is moving. Moreover, there is additional time needed to transmit, access and/or process the real-time location of the mobile resource. Accordingly, the actual instantaneous location of the mobile resource may be slightly different than the real-time location accessed by the real-time mobile resource location data accessor 120.

Correlator 130 correlates task schedule data 102, mobile resource input data 103, and/or real-time mobile resource location data 104. In other words, correlator 130 receives, combines and/or determines any relationship between task schedule data 102, mobile resource input data 103 and/or real-time mobile resource location data 104. For example, correlator 130 provides analysis for understanding how real-time mobile resource location data 104 (e.g., task destinations, mobile resource movements) correlate with task schedule data 102 (e.g., scheduled tasks, scheduled destinations, scheduled travelling times). In one embodiment, task schedule data 102 includes (1) a pre-planned mobile resource location and (2) a pre-planned mobile resource activity with respect to the scheduled task, and correlator 130 correlates task schedule data 102 with real-time mobile resource location data 104 that includes the real-time location of the mobile resource.

In one embodiment, correlator 130 includes compliance determinor 135. Compliance determinor 135 determines compliance of the scheduled location of the mobile resource with the real-time location of the mobile resource. For example, with reference to FIG. 2C, Employee A is scheduled to complete Task B at Location B 240 after completing Task A at Location A 210 and remain within task vicinity 215. If Employee A exits task vicinity 215 to go to Location D 240 (e.g., the home of Employee A), then the real-time location of Employee A is not in compliance with task schedule 200C. Accordingly, compliance determinor 135 determines that the real-time location of Employee A is not in compliance with task schedule 200C.

In reference to FIG. 1, mobile resource task scheduling system 100 also includes a dynamic task rescheduler 140, alert generator 150 and report generator 160.

Dynamic task rescheduler 140 dynamically reschedules a scheduled task based at least on real-time mobile resource location data 104. For example, if the real-time location of the mobile resource is not in compliance with a scheduled location of the mobile resource, then, in one embodiment, the dynamic task rescheduler 140 dynamically reschedules the pre-planned scheduled task in real-time. In one embodiment, dynamic task rescheduler 140 receives correlated data 133 from correlator 130 and reschedules a scheduled task based on the correlated data 133.

For example, with reference to FIG. 2C, Employee A is scheduled to be at Location B 220 and initiating Task B at 4:30 PM and complete Task B by 5:00 PM. However, Employee A is at Location D 240 at 4:20 PM which is 30 minutes away (travelling time) from Location B 220. Therefore, Employee A cannot travel to Location B 220 and arrive at the scheduled time of 4:30 PM and complete Task B by the scheduled time of 5:00 PM. Accordingly, dynamic task rescheduler 140 dynamically reschedules one or more tasks in task schedule 200C such that Employee A is rescheduled to arrive at Location B 220 and initiate Task B at 4:50 PM and complete Task B by 5:20 PM. In another embodiment, dynamic task rescheduler 140 dynamically reschedules one or more tasks in task schedule 200C such that Employee A is no longer scheduled to complete Task B and Employee B located at Location C 230 is rescheduled to travel to Location B 220 and initiate Task B at 4:30 PM and complete Task B by 5:00 PM.

In another embodiment, with reference to FIG. 2C, Employee A is scheduled to accomplish Task A at Location A 210 and Task B at Location B 220 by 5:00 PM. At 3:00 PM, a high priority Task C required to be accomplished by 5:00 PM (and requiring an hour and thirty minutes to be completed) is to be scheduled at Location C 230 (which is a one hour travel time from Location A 230), while Employee A is still at Location A 210 and Employee B is at Location D 240 (which is only a 30 minute travel time from Location C) with no scheduled tasks to accomplish. Accordingly, dynamic task rescheduler 140 dynamically reschedules one or more tasks of a task schedule 200C and/or adds new tasks such that Employee B is rescheduled to travel to Location C 230 and complete Task C by 5:00 PM, while Employee A continues to accomplish the scheduled tasks already assigned.

Alert generator 150 is configured to generate alert 155 in real-time based on the correlation of task schedule data 102, mobile resource input data 103 and/or real-time mobile resource data 104. It should be appreciated that alert 155 is transmitted to any relevant person associated with a scheduled task, such as, but not limited to, a mobile resource, a manager and/or a controller. It should also be appreciated that alert 155 is generated and transmitted at a particular point in time based on mismatch in the correlation of data against the schedule plan, e.g. when a scheduled task is not being completed as according to plan.

In one embodiment, alert 155 is generated in response to a determination (i.e., receiving correlated data 133) that real-time mobile resource location data 104 is non-compliant with a scheduled location of the mobile resource. For example, in reference to FIG. 2C, Employee A is scheduled to accomplish Task A and Task B within the task vicinity 215. If Employee A is outside of task vicinity 215 (e.g., Location D 240), then Employee A's real-time location is not in compliance with the scheduled task in task schedule 200C. Accordingly, alert generator 150 generates an alert 155. Alert 155 indicates that the real-time mobile resource location data 104 (e.g., Location E 250) is not in compliance with the scheduled location (e.g., task vicinity 215) of the mobile resource. It should be appreciated that alert 155 can be transmitted to any person (e.g., employee, manager, scheduler, etc) associated with the scheduled task. Alerts 155 can be transmitted, accessed, received via email, cell phone, pager, instant messaging, any short message service (SMS) and the like.

In various embodiments, alert generator 150 uses task vicinity, mobile resource start and finish locations, GPS tracked locations and times, and mobile resource attendance times to determine if alerts should be generated (where resource attendance excludes absences and also takes into account any travel in own time). Based on these times/durations, an expected start time and expected finish time (e.g., when a mobile resource should have parked at their finish location) is determined for use by different alerts.

In one embodiment, alert 155 is a late start alert. Alert generator 150 generates and transmits a late start alert in response to the mobile resource not moving from a start location within a scheduled start time window. This allows an early assessment to be carried out of any impact to the work assigned to a mobile resource that is late starting.

In another embodiment, alert 155 is a task completion proximity alert. Alert generator 150 generates and transmits a task completion proximity alert in response to the task associated with the mobile resource not being closed within a scheduled task completion time window. For example, Employee A is scheduled to finish Task A sometime in a time window of 4:30 PM to 5:00 PM. If Employee A does not complete Task A and affirmatively close out Task A between 4:30 PM and 5:00 PM, then alert generator 150 generates and transmits a task completion proximity alert. The proximity to completion time is configurable and can be adjusted to give an early warning (e.g., a jeopardy mode) or a late alert (e.g., a health and safety mode) to prompt a coordinator to make contact with the mobile resource to determine that the mobile resource is not in any difficulty personally or with the scheduled task. It should be appreciated that a task completion proximity alert is transmitted in response to a task associated with a mobile resource not being closed within a period of time before and/or after the scheduled task completion.

In a further embodiment, alert 155 is a moved before closing task alert. Alert generator 150 generates and transmits a moved before closing task alert in response to the mobile resource moving outside a task vicinity before the task is registered to be completed. For example, if Employee A is scheduled to complete Task C and Employee A leaves a task vicinity area before Task C is registered to be completed, then alert generator 150 generates and transmits a moved before closing task alert (even if Task C is actually completed, but Employee A has not affirmatively registered Task C as completed).

In yet another embodiment, alert 155 is a closed task no movement alert. Alert generator 150 generates and transmits a closed task no movement alert in response to the mobile resource not moving to a next planned location within a configurable time window. For example, Employee A is scheduled to complete Task A at 12:00 PM and start moving to Location B 230 to initiate completion of Task B by 1:00 PM. However, if Employee A has not started moving to Location B within a configurable time window (after completing Task A), then alert generator 150 generates and transmits a closed task no movement alert. It should be appreciated that the next planned location can be, but is not limited to, a finish location or a task location.

In one embodiment, alert 155 is an outside task vicinity alert. Alert generator 150 generates and transmits an outside vicinity alert in response to the mobile resource being located outside of a defined task vicinity. In other words, an outside task vicinity alert is generated when a mobile resource makes an unexpected stop outside a task vicinity. For example, if a mobile resource is parked or pauses for more than a configurable amount of time at a location that is not in the task vicinity that has been dispatched to the mobile resource, then alert generator 150 generates and transmits an outside vicinity alert.

Alert(s) 155 can also include manager/line manager alerts such as an out of hours alert and a safe finish alert. Although these are primarily manager/line manager alerts, they can also be sent to out of hours control and/or the mobile resource. It should be appreciated that the line manager is a manager that oversees the mobile resources. In one embodiment, alert generator 150 generates and transmits an out of hours alert is transmitted if a mobile resource (e.g., vehicle) is moved outside of a normal working hours (where normal working hours are configurable).

In one embodiment, alert generator 150 generates and transmits a safe finish alert if a mobile resource has not arrived at its finish location in a specified time window (after the expected finish time). In other words, a safe finish alert is transmitted in response to the mobile resource failing to arrive at a finish location, within a configurable time window, after a planned finish time. The safe finish alert can trigger a response such as a report-in by a mobile resource or a check-up by a manager or other person to in order to ensure the mobile resource is not in any personal and/or task difficulty.

In another embodiment, alert generator 150 generates and transmits a late arrival alert if it appears and/or is expected that a mobile resource will arrive late to a task location such that they may not start and/or finish a task on time.

In a further embodiment, alert generator 150 generates an early finish alert. In one embodiment, an early finish alert is transmitted in response to the mobile resource arriving early, within a configurable time window, before a planned finish time. For example, if a mobile resource is scheduled to complete their last task and arrive at their finish location at 5:00 PM and the mobile resource is at, or arrives at, their finish location at 3:00 PM, which is within a configurable window of time before their finish time, then an early finish alert is transmitted. The early finish alert allows a manager and/or controller to schedule a mobile resource with additional tasks, if needed, rather than the mobile resource from stopping for the rest of the day.

Alerts can be monitored in a variety of ways. Alerts can be monitored by being displayed on a display with a view of other mobile resources, which will be discussed in detail below. Alerts can be filtered by domain and optionally a team. Filter settings can be saved for future use. Alerts can be displayed on a map for an individual resource, along with their tour of scheduled tasks including the location of the tasks to be executed in that tour and movements throughout the day. Scheduled, unscheduled and closed tasks can be displayed on the map by scheduling system 100. Scheduling system 100 also facilitates finding mobile resources for a task and measuring the distance between the items displayed on the map.

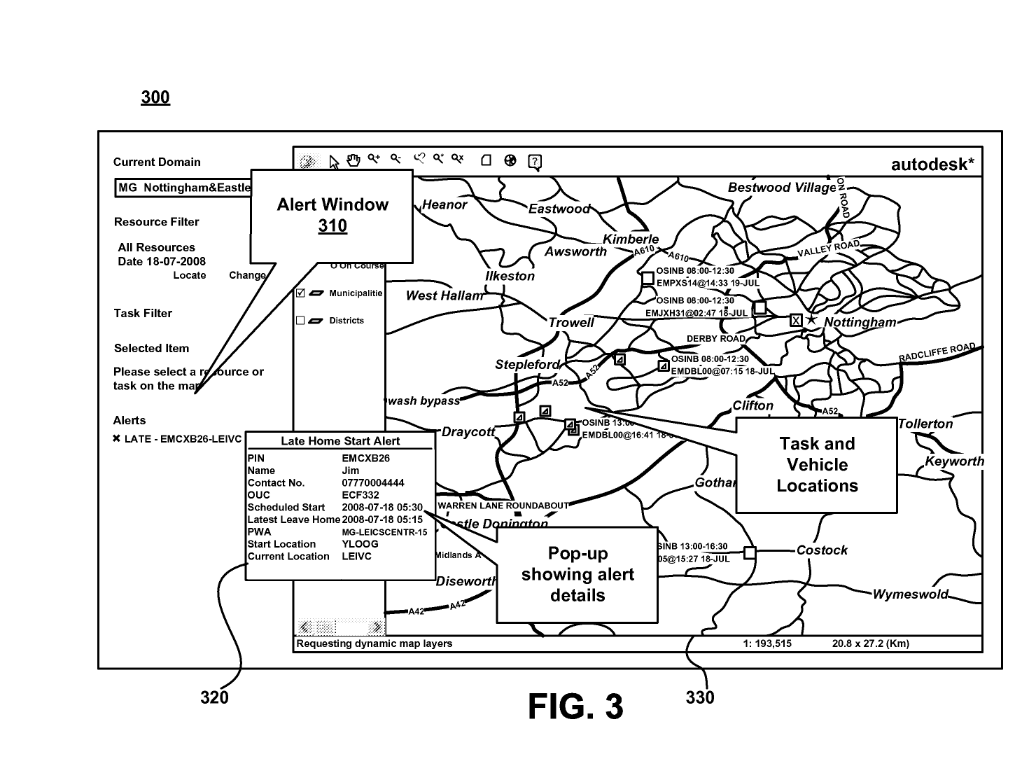

FIG. 3 illustrates a display 300, in accordance with an embodiment. Display 300 displays an alert window 310, a pop-up alert window 320 and a map 330. In one embodiment, scheduling system 100 displays display 300 on a display device (e.g., display device 618 of computer system 600). In one embodiment, display 300 displays a late start alert, as described above. Alert window 310 displays one or more alert(s) 155. A pop-up alert window 320 is configured to display the details of any alert displayed (e.g., a late start alert). A variety of information such as but not limited to task schedule data 102 and real-time mobile resource location data 104 can be displayed on map 330. It should be appreciated that, in some embodiments, display 300 concurrently displays dynamically rescheduled task schedule data and the real-time mobile resource location data of the mobile resource on a map. It should also be appreciated that display 300 is utilized with system 100 to display any data associated with task schedule data 102 and/or real-time mobile resource location data 104. A display 300 can display one or any combination of correlated data 133, rescheduled task data 145, alert 155 and report 165.

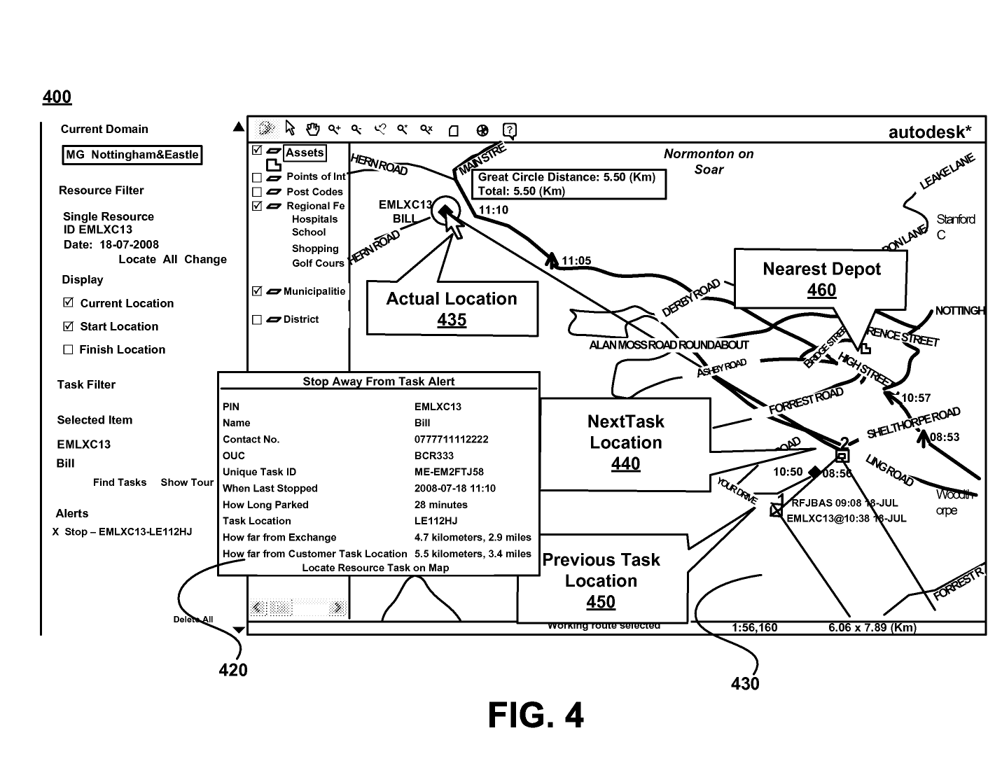

FIG. 4 illustrates a display 400, in accordance with an embodiment. In one embodiment, scheduling system 100 displays display 300 on a display device (e.g., display device 618 of computer system 600). Display 400 displays a pop-up alert window 420 (which functions similarly to pop-up alert window 320) and a map 430. A pop-up alert window 420 is configured to display the details of any alert 155 that is displayed in conjunction with display 400. In display 400, pop-up alert window 410 displays a stop away from task alert, however it is appreciated that pop-up alert window can display any other alert 155. A variety of information such as but not limited to task schedule data 102 and real-time mobile resource location data 104 can be displayed on map 430. For example, map 430 displays an actual location 435 (or real-time location) of a mobile resource, a next task location 440, a previous task location 450 and a nearest depot 460. The depot 460 can be for, but not limited, to storing assets.

Referring to FIG. 1, report generator 160 is configured to generate a report 165 associated with the mobile resource and the scheduled task. Report(s) 165 can directly affect the efficiency of mobile resources. Report(s) 165 include a variety of information, such as, but not limited to task schedule data 102, mobile resource input data 103 and/or real-time mobile resource location data 104 to illustrate the activities/inactivities of mobile resources throughout the day.

For example, report(s) 165 illustrate how much time a mobile resources work on a task that they should be working on, based on time spent parked within the vicinity of a task and any travel between locations within the vicinity of a task; and how much time they are not working on a task, which includes, but is not limited to, time spent travelling to/from/between tasks, time spent travelling to/from off site locations and time spent parked off site. By viewing and analyzing the inefficient time and efficient time spend throughout a day, as shown by a report, it becomes possible to identify inefficiencies in business processes and/or mobile resources working behaviors that may otherwise remain undiscovered, and make changes in order to become more efficient in accomplishing a scheduled plan.

It should be appreciated that the reports can be available to any person associated with a scheduled task, such as, but not limited to, a mobile resource, a manager, a controller and the like. It should also be appreciated that reports can be displayed on a display and can be filtered by domain and optionally a team.

In one embodiment, report 165 is a divisional report. A divisional report is a summary report of each team (e.g., a plurality of associated mobile resources) in a region, domain or hierarchical group of teams. Report 165 displays, for each team, the efficiency and effectiveness as well as ineffective time and onsite time. In another embodiment, report 165 is a team report. A team report is a summary at a group/team level for each mobile resource in a selected team that shows their contribution to the team's overall efficiency and effectiveness along with ineffective time and onsite time.

In one embodiment, report 165 is a mobile resource report. A mobile resource report is a summary at a task level for each task dispatched to a specific mobile resource. The mobile resource summary report provides details on the time spent working on each task and the efficiency of the actual time spent as compared with a task schedule's estimated duration of time for completing a task. In another embodiment, report 165 is a task events report. A task events report is a summary report for each specific task. It provides a step-by-step list of the events that occurred during the period of time that the task was dispatched to the mobile resource. The report also includes the GPS park and move events, whether the mobile resource was within the task vicinity, changes in task status and the timing of the events.

In a further embodiment, report 165 is a field resource events report. A field resource events report is a step-by-step list of the events that occurred during a mobile resource's working day. It includes all GPS park and move events, whether they were within the task vicinity, changes in task status for each task issued to the mobile resource and the timing of the events for the whole working day. In yet another embodiment, report 165 is a control user report. A control user report supports the generation of reports such that a controller's performance for managing alerts can be assessed. In one embodiment, report 165 is an aggregated performance summary report for a group of mobile resources. In various embodiments, report 165 is generated based on a team level, domain level, geographic area, any organizational hierarchy, and the like.

### Example Methods of Operation

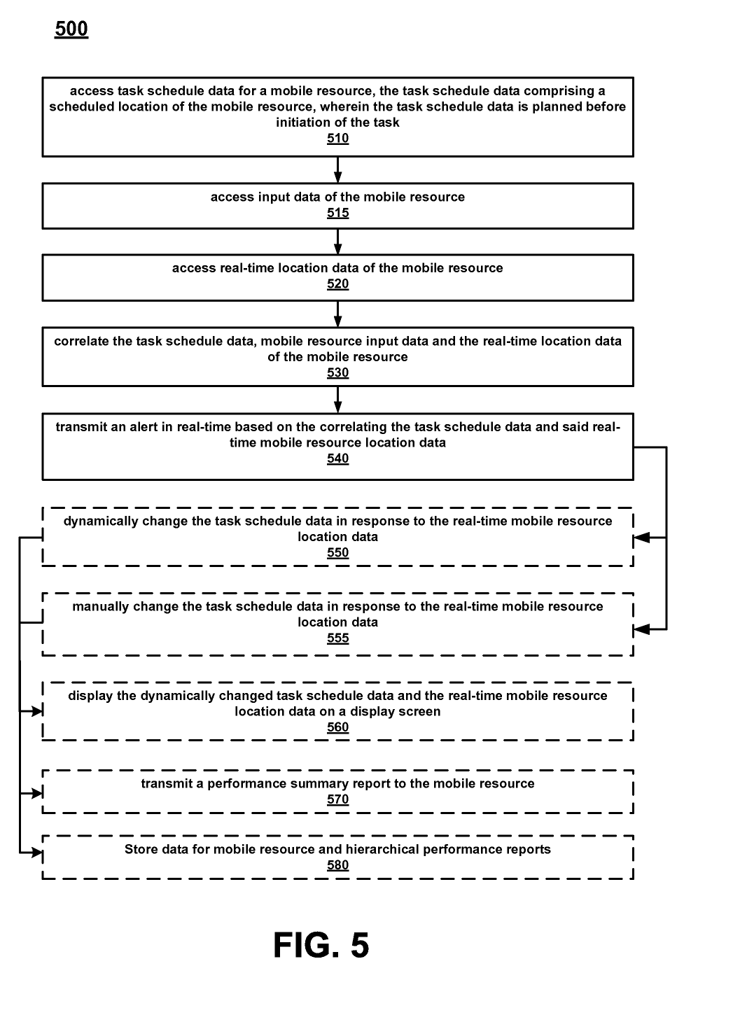

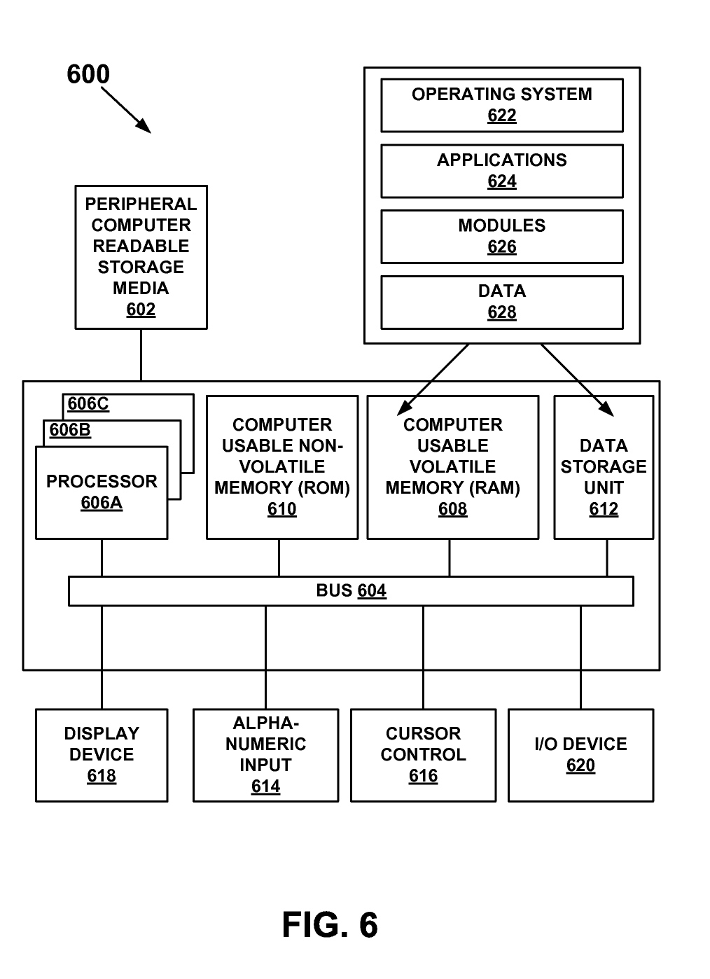

The following discussion sets forth in detail the operation of some example methods of operation of embodiments. With reference to FIG. 5, flow diagram 500 illustrates example procedures used by various embodiments. Flow diagram 500 includes some procedures that, in various embodiments, are carried out by a processor under the control of computer-readable and computer-executable instructions. In this fashion, flow diagram 500 is implemented using a computer, in various embodiments. The computer-readable and computer-executable instructions can reside in any tangible computer readable storage media, such as, for example, in data storage features such as computer usable volatile memory 608, computer usable non-volatile memory 610, peripheral computer-readable storage media 602, and/or data storage unit 612 (all of FIG. 6). The computer-readable and computer-executable instructions, which reside on tangible computer readable storage media, are used to control or operate in conjunction with, for example, one or some combination of processors 606A, 606B, and 606C of FIG. 6, or other similar processor(s). Although specific procedures are disclosed in flow diagram 500, such procedures are examples. That is, embodiments are well suited to performing various other procedures or variations of the procedures recited in flow diagram 500. Likewise, in some embodiments, the procedures in flow diagram 500 may be performed in an order different than presented and/or not all of the procedures described in one or both of these flow diagrams may be performed.

### Example Method for Mobile Resource Task Scheduling

FIG. 5 illustrates a flow diagram 500 of an example embodiment of a method for mobile resource task scheduling. The method facilitates scheduling one or more tasks for a mobile resource. In one embodiment, one or more procedures in flow diagram 500 are implemented using scheduling system 100.

At 510, task schedule data for a mobile resource is accessed. In one embodiment, task schedule data is accessed for a mobile resource, the task schedule data comprising a scheduled location of the mobile resource, wherein the task schedule data is planned before initiation of the task. In another embodiment, this comprises task schedule data accessor 110 of scheduling system 100 accessing task schedule data 102 for a mobile resource.

At step 515, input data of the mobile resource is accessed. For example, this comprises mobile resource input data accessor 115 of scheduling system 100 accessing mobile resource input data 103.

At 520, real-time location data of the mobile resource is accessed. In one embodiment, this comprises real-time mobile resource location data accessor 120 of scheduling system 100 accessing task schedule data 102 for a mobile resource.

At 530, the task schedule data and the real-time location data of the mobile resource are correlated. In one embodiment, the two streams of data are correlated. For example, the two streams of data are correlated by correlator 130. In another embodiment, the compliance of the scheduled location of the mobile resource associated with a real-time location of the mobile resource is determined. For example, compliance is determined by compliance determinor 135. In yet another embodiment, compliance of a task vicinity associated with the real-time mobile resource location is determined. In another embodiment, the task schedule data, the mobile resource input data and the real-time location data of the mobile resource are correlated.

At 540, an alert is transmitted based on correlating the task schedule data and the real-time mobile resource location data. In one embodiment, this comprises alert generator 150 generating and transmitting alert(s) 155. For example, an alert 155 is transmitted if a mobile resource is located outside of task vicinity 210. In one embodiment, a late start alert is transmitted in response to the mobile resource not moving from a start location within a scheduled start time window. In another embodiment, a task completion proximity alert is transmitted in response to the task associated with the mobile resource not being closed within a scheduled task completion time window. In yet another embodiment, a moved before closing task alert is transmitted in response to the mobile resource moving outside a task vicinity before the task is registered to be completed. In another embodiment, an alert is transmitted based on correlating the task schedule data, the mobile resource input data and the real-time mobile resource location data.

In a further embodiment, a closed task no movement alert is transmitted in response to the mobile resource not moving to a scheduled subsequent task within a scheduled time window after a previous task associated with the mobile resource is completed. In one embodiment, an outside task vicinity alert is transmitted in response to the mobile resource being located outside of a defined task vicinity. In another embodiment, an alert is transmitted in real-time to the mobile resource. For example, alerts 320 and 410 are transmitted to the mobile resource.

In one embodiment, a late arrival at task alert is transmitted in response to the mobile resource arriving late to a scheduled task location. In another embodiment, an early finish alert is transmitted in response to the mobile resource finishing scheduled tasks before a scheduled completion time.

At 550, the task schedule data is dynamically changed in response to real-time correlated data. For example, the task schedule data 102 is dynamically changed by dynamic task rescheduler 140. In one embodiment, the task from a first mobile resource is dynamically reassigned to a second mobile resource in response to the real-time correlated data. In another embodiment, the task schedule data is dynamically changed in response to the real-time correlated data. In yet another embodiment, the task schedule data is dynamically changed to add an additional task in response to the real-time correlated data. In various embodiments, real-time correlated data is any combination of correlated task schedule data, mobile resource input data and/or real-time mobile resource location data.

At 555, the task schedule data is manually changed in response to the real-time mobile resource location data. For example, a manager manually changes the task schedule data in response to observed real-time mobile resource location data 104.

At 560, the dynamically changed task schedule data and the real-time mobile resource location data are displayed on a display screen. In one embodiment, the dynamically changed task schedule data and the real-time mobile resource location data on the display screen are displayed at the mobile resource. For example, the real-time or actual location 410 of a mobile resource is displayed on a display 400 with a task location 440 that has been dynamically changed from a pre-planned task location.

At 570, a performance summary report is transmitted to the mobile resource. In one embodiment, this comprises report generator 165 generating and transmitting a report 165. For example, a report 165 is transmitted from report generator 160 to a mobile resource. In another embodiment, an aggregate performance summary report is transmitted to a group of mobile resources.

At 580, mobile resource and hierarchical performance reports data are stored. For example, data can be stored in data storage unit 621, described in detail below. Such stored performance reports can be provided to one or more entities, such as managers, mobile workers, teams, or other hierarchical/geographical groups and/or entities.

### Example Computer System Environment

With reference now to FIG. 6, all or portions of some embodiments described herein are composed of computer-readable and computer-executable instructions that reside, for example, in computer-usable/computer-readable storage media of a computer system. That is, FIG. 6 illustrates one example of a type of computer (computer system 600) that can be used in accordance with or to implement various embodiments which are discussed herein. It is appreciated that computer system 600 of FIG. 6 is only an example and that embodiments as described herein can operate on or within a number of different computer systems including, but not limited to, general purpose networked computer systems, embedded computer systems, routers, switches, server devices, client devices, various intermediate devices/nodes, stand alone computer systems, server blades, and the like. Computer system 600 of FIG. 6 is well adapted to having peripheral computer-readable storage media 602 such as, for example, a floppy disk, a compact disc, a digital versatile disc (DVD), a USB (universal serial bus) flash memory drive and the like coupled thereto.

System 600 of FIG. 6 includes an address/data bus 604 for communicating information, and a processor 606A coupled to bus 604 for processing information and instructions. As depicted in FIG. 6, system 600 is also well suited to a multi-processor environment in which a plurality of processors 606A, 606B, and 606C are present. Conversely, system 600 is also well suited to having a single processor such as, for example, processor 606A. Processors 606A, 606B, and 606C may be any of various types of microprocessors. System 600 also includes data storage features such as a computer usable volatile memory 608, e.g. random access memory (RAM), coupled to bus 604 for storing information and instructions for processors 606A, 606B, and 606C. System 600 also includes computer usable non-volatile memory 610, e.g. read only memory (ROM), coupled to bus 604 for storing static information and instructions for processors 606A, 606B, and 606C. Also present in system 600 is a data storage unit 612 (e.g., a magnetic or optical disk and disk drive) coupled to bus 604 for storing information and instructions.

In some embodiments, system 600 also optionally includes other components. For example, system 600 also includes an optional alphanumeric input device 614 including alphanumeric and function keys coupled to bus 604 for communicating information and command selections to processor 606A or processors 606A, 606B, and 606C. System 600 also includes an optional cursor control device 616 coupled to bus 604 for communicating user input information and command selections to processor 606A or processors 606A, 606B, and 606C. In one embodiment, system 600 also includes an optional display device 618 coupled to bus 604 for displaying information.

Referring still to FIG. 6, optional display device 618 of FIG. 6 may be a liquid crystal device, cathode ray tube, plasma display device or other display device suitable for creating graphic images and alphanumeric characters recognizable to a user. Optional cursor control device 616 allows the computer user to dynamically signal the movement of a visible symbol (cursor) on a display screen of display device 618 and indicate user selections of selectable items displayed on display device 618. Many implementations of cursor control device 616 are known in the art including a trackball, mouse, touch pad, joystick or special keys on alphanumeric input device 614 capable of signaling movement of a given direction or manner of displacement. Alternatively, it will be appreciated that a cursor can be directed and/or activated via input from alphanumeric input device 614 using special keys and key sequence commands. System 600 is also well suited to having a cursor directed by other means such as, for example, voice commands. System 600 also includes an I/O device 620 for coupling system 600 with external entities. For example, in one embodiment, I/O device 620 is a modem for enabling wired or wireless communications between system 600 and an external network such as, but not limited to, the Internet.

Referring still to FIG. 6, various other components are depicted for system 600. Specifically, when present, an operating system 622, applications 624, modules 626, and data 628 are shown as typically residing in one or some combination of computer usable volatile memory 608 (e.g., RAM), computer usable non-volatile memory 610 (e.g., ROM), and data storage unit 612. In some embodiments, all or portions of various embodiments described herein are stored, for example, as an application 624 and/or module 626 in memory locations within RAM 608, computer-readable storage media within data storage unit 612, peripheral computer-readable storage media 602, and/or other tangible computer readable storage media.

Various embodiments of the present invention are thus described. While the present invention has been described in particular embodiments, it should be appreciated that the present invention should not be construed as limited by such embodiments, but rather construed according to the following claims.

What is claimed is:

1. A computer-implemented method for mobile resource task scheduling, said method comprising:
accessing task schedule data for a mobile resource, said task schedule data comprising a scheduled location of said mobile resource, wherein said task schedule data is planned before initiation of said task;
accessing real-time location data of said mobile resource;
correlating said task schedule data and said real-time location data of said mobile resource; and
transmitting an alert in real-time based on said correlated task schedule data and real-time mobile resource location data.

2. The computer-implemented method of claim 1, further comprising:
dynamically changing said task schedule data in response to said real-time mobile resource location data.

3. The computer-implemented method of claim 1, further comprising:
accessing mobile resource input data.

4. The computer-implemented method of claim 1, wherein said correlating said task schedule data and said real-time location data of said mobile resource comprises:
correlating said task schedule data, said real-time location data of said mobile resource and mobile resource input data.

5. The computer-implemented method of claim 4, wherein said correlating said task schedule data, said real-time location data of said mobile resource and mobile resource input data comprises:
determining compliance of said scheduled location of said mobile resource with a real-time location of said mobile resource.

6. The computer-implemented method of claim 4, wherein said correlating said task schedule data, said real-time location data of said mobile resource and mobile resource input data comprises:
determining compliance of a task vicinity with a real-time location of said mobile resource.

7. The computer-implemented method of claim 1, wherein said transmitting an alert in real-time in response to correlating said task schedule data and said real-time mobile resource location data comprises:
transmitting an alert in real-time in response to correlating said task schedule data, said real-time mobile resource location data and mobile resource input data.

8. The computer-implemented method of claim 1, further comprising:
transmitting an alert in real-time in response to determining said real-time mobile resource location data or mobile resource input data is non-compliant with said scheduled data.

9. The computer-implemented method of claim 1, further comprising:
transmitting an alert in real-time in response to determining said real-time mobile resource location data and mobile resource input data is non-compliant with said scheduled data.

10. The computer-implemented method of claim 1, wherein said transmitting an alert in real-time comprises:
transmitting a late start alert in response to said mobile resource not moving from a start location within a scheduled start time window.

11. The computer-implemented method of claim 1, wherein said transmitting an alert in real-time comprises:
transmitting a task completion proximity alert in response to said task associated with said mobile resource not being closed within a period of time before a scheduled task completion time.

12. The computer-implemented method of claim 1, wherein said transmitting an alert in real-time comprises:
transmitting a task completion proximity alert in response to said task associated with said mobile resource not being closed within a period of time after a scheduled task completion time.

13. The computer-implemented method of claim 1, wherein said transmitting an alert in real-time comprises:
transmitting a moved before closing task alert in response to said mobile resource moving outside a task vicinity before said task is registered to be completed.

14. The computer-implemented method of claim 1, wherein said transmitting an alert in real-time comprises:
transmitting a closed task no movement alert in response to said mobile resource not moving to a next planned location within a configurable time window.

15. The computer-implemented method of claim 1, wherein said transmitting an alert in real-time comprises:
transmitting an outside task vicinity alert in response to said mobile resource being located outside of a defined task vicinity.

16. The computer-implemented method of claim 1, wherein said transmitting an alert in real-time comprises:
transmitting a late arrival at task alert in response to said mobile resource expected to arrive late to a scheduled task location.

17. The computer-implemented method of claim 1, wherein said transmitting an alert in real-time comprises:
transmitting an early finish alert in response to said mobile resource arriving early, within a configurable time window, before a planned finish time.

18. The computer-implemented method of claim 1, wherein said transmitting an alert in real-time comprises:
transmitting a safe finish alert in response to said mobile resource failing to arrive at a finish location, within a configurable time window, after a planned finish time.

19. A computer-usable storage medium having instructions embodied therein that when executed cause a computer system to perform a method for mobile resource task scheduling, said method comprising:
accessing task schedule data for a mobile resource, said task schedule data comprising a scheduled location of said mobile resource, wherein said task schedule data is planned before initiation of said task;
accessing real-time location data of said mobile resource;
accessing mobile resource input data;
correlating said task schedule data, said mobile resource input data and said real-time location data of said mobile resource; and
transmitting an alert in real-time based on said correlated task schedule data, said mobile resource input data and said real-time mobile resource location data.

20. The computer-usable storage medium of claim 19, further comprising instructions for:
displaying said dynamically changed task schedule data and said real-time mobile resource location data on a display screen.

21. The computer-usable storage medium of claim 20, wherein displaying said dynamically changed task schedule data and said real-time mobile resource location on a display screen comprising instructions for:
displaying said dynamically changed task schedule data and said real-time mobile resource location data on said display screen at said mobile resource.

22. The computer-usable storage medium of claim 19, further comprising instructions for:
dynamically changing said task schedule data in response to said real-time mobile resource location data.

23. The computer-usable storage medium of claim 19, wherein said transmitting an alert in real-time further comprises instructions for:
transmitting said alert in real-time in response to determining said real-time mobile resource location data that is non-compliant with said scheduled location.

24. The computer-usable storage medium of claim 19, further comprising instructions for:
transmitting a performance summary report to said mobile resource.

25. The computer-usable storage medium of claim 19, further comprising instructions for:
transmitting an aggregated performance summary report for a group of mobile resources.

26. A system comprising:
a task schedule data accessor configured to access task schedule data of a task for a mobile resource, said task schedule data comprising a scheduled location of said mobile resource, wherein said task schedule data is planned before initiation of said task;
a real-time mobile resource location data accessor configured to access real-time location of said mobile resource;
a mobile resource input data accessor configured to access input data of said mobile resource;
a correlator configured to correlate said task schedule data, said mobile resource input data and said real-time mobile resource location data; and
an alert generator configured to generate an alert base on said correlated real-time mobile resource location data, said mobile resource input data and said scheduled location data.

27. The system of claim 26, further comprising:
a report generator configured to generate a report associated with said mobile resource and said task.

28. The system of claim 26, further comprising:
a display, wherein said display displays dynamically rescheduled task schedule data and said real-time mobile resource location.

29. The system of claim 26, further comprising:
a dynamic task rescheduler configured to dynamically reschedule said task based at least on said real-time mobile resource location data.

30. The system of claim 29, wherein said dynamic task rescheduler is further configured to cause said dynamically rescheduled task schedule data and said real-time mobile resource location data to concurrently display on a map at said mobile resource.

31. The system of claim 26, wherein said correlator further comprises:
a compliance determinor configured to determine compliance of said scheduled location of said mobile resource associated with said real-time location of said mobile resource.

32. The system of claim 26, wherein said alert generator configured to generate an alert comprises:
an alert generator configured to generate said alert based on said correlated real-time mobile resource location data, said scheduled location data and said mobile resource input data.
